(19) United States
(12) Patent Application Publication
(10) Pub. No.: US 2012/0304697 A1
(43) Pub. Date: Dec. 6, 2012

(54) DEVICE FOR OBTAINING A MULTICRYSTALLINE SEMICONDUCTOR MATERIAL, IN PARTICULAR SILICON, AND METHOD FOR CONTROLLING THE TEMPERATURE THEREIN

(75) Inventors: Fabrizio Dughiero, Piove Di Sacco (IT); Michele Forzan, Padova (IT); Dario Ciscato, Gazzo (IT); Mariolino Cesano, San Germano Vercellese (IT); Fabrizio Crivello, San Martino Canavese (IT); Roberto Bechini, San Benigno Canavese (IT)

(73) Assignee: SAET S.P.A., Leini' (IT)

(21) Appl. No.: 13/503,283

(22) PCT Filed: Oct. 20, 2010
(86) PCT No.: PCT/IB2010/002686

§ 371 Date: Aug. 2, 2012

(30) Foreign Application Priority Data
Oct. 21, 2009 (IT) TO2009A000794

(51) Int. Cl. C03B 19/02

(52) U.S. Cl. 65/33.9; 65/355

(57) ABSTRACT

A device for obtaining multicrystalline silicon, including: at least one crucible made of quartz for the silicon, removably housed in a cup-shaped graphite container; a fluid-tight openable casing; a top induction coil, set facing, with interposition of a graphite plate, the crucible, a lateral induction coil, set around a side wall of the graphite container, and a bottom induction coil, set facing a bottom wall of the graphite container and vertically mobile for varying the distance from the bottom wall; and first means for a.c. electrical supply of the induction coils separately from one another, and second means for supply of a coolant within respective hollow turns of the induction coils; the bottom induction coil includes four spiral windings, arranged alongside one another; electrical switching means enable in use selective connection of the four windings to one another according to different configurations.

### TECHNICAL FIELD

The present invention relates to a device for obtaining a multicrystalline semiconductor material, in particular silicon, by melting of the semiconductor material and subsequent directional solidification thereof, as well as to a method for obtaining a better control of the temperature of the semiconductor material.

### BACKGROUND ART

The demand for semiconductor material, in particular silicon, with a high degree of purity, referred to as “solar purity”, is increasingly higher, in so far as said material serves for the production of high-efficiency photovoltaic cells.

To obtain such a material refinements are first made by means of traditional metallurgical processes and, finally, an ingot is formed, from which the wafers necessary for production of the photovoltaic cells can then be sectioned. Said ingot is formed with a methodology known as “Directional Solidification System” (DSS), i.e., by melting the semiconductor material in a crucible, and then causing a directional solidification thereof, obtaining, at the end, multicrystalline silicon.

To obtain the directional solidification it is necessary to bring about said solidification in the crucible by maintaining a vertical thermal gradient in the ingot being formed so as to obtain a rate of cooling such as to obtain advance of the solidification front at a rate of 1-2 cm/h. An advantage of said technology is that the impurities present in the starting material remain preferentially in the molten material and consequently rise upwards together with the solidification front. Once the ingot is solidified, it is consequently sufficient to eliminate the top part of the ingot itself to obtain refined multicrystalline silicon at the desired degree of purity.

To obtain said result it is necessary to be able to exert a very precise control of the thermal flows. Furthermore, the step of melting of the solid semiconductor material to be refined requires long times and high levels of energy consumption.

### DISCLOSURE OF INVENTION

The aim of the present invention is to overcome the drawbacks of the known art by providing a device made of a semiconductor material, typically multicrystalline silicon with “solar” degree of purity, as well as a method for controlling the temperature thereof that will be simple and inexpensive to implement, will enable a reliable and effective control of the thermal flows, and will enable reduction of the overall dimensions and the levels of energy consumption of the necessary equipment.

Here and in what follows by “solar” degree of purity is meant the degree of purity necessary for producing high-efficiency photovoltaic cells.

The invention hence regards a device for melting and subsequent directional solidification of a semiconductor material, typically to obtain multicrystalline silicon with solar degree of purity, according to claim 1, and to a method for carrying out control of the temperature in a process of refinement of a semiconductor material in which the semiconductor material is melted and is subsequently subjected to directional solidification, according to claim 9.

In particular, the device of the invention comprises: at least one crucible for the semiconductor material, preferably made of quartz or ceramic material, removably housed in a cup-shaped graphite container; a possible openable and fluid-tight casing, housing inside it the graphite container; one or more top induction coils, the induction coil being set facing, with interposition of a graphite plate, a mouth of the graphite container; one or more lateral induction coils, arranged around a side wall of the graphite container; one or more bottom induction coils, set facing a bottom wall of the graphite container; a.c. electrical-supply means for supplying the induction coils separately and independently of one another; and cooling means for supplying a coolant within respective hollow turns of the induction coils.

According to one aspect of the invention, the bottom block of induction coils comprises a plurality of windings arranged alongside one another in one and the same plane of lie defined by an insulated supporting plate, and electrical switching means are prearranged between the windings of the bottom induction coil and the respective a.c. electrical-supply means for selectively connecting the windings to one another according to different configurations, which differ from one another as regards the direction of circulation of the electric current in the respective windings set alongside one another.

Consequently, according to the method of the invention, the melting step is performed by heating the semiconductor material contained in a crucible by means of graphite susceptors, each operatively associated to at least one respective induction coil and arranged so as to surround the crucible, and, in order to obtain the desired control of the temperature, the following steps are performed:
setting under the crucible a susceptor, operatively associated to at least one bottom induction coil comprising a plurality of windings arranged alongside one another in one and the same plane of lie; and
selectively connecting the windings to one another and to respective a.c. electrical-supply means for supply of the bottom induction coil according to different configurations that differ from one another as regards the direction of circulation of the electric currents in the respective windings set alongside one another.

In this way, it is possible to vary with extreme simplicity and in a way that can be implemented a number of times during one and the same process the heat that the bottom graphite susceptor supplies to the crucible, without substantially altering any other operating parameter of the device, and in particular of the induction coils.

Preferably, moreover, the bottom induction coil is mobile so that its distance from the susceptor associated thereto can be varied both during the step of melting and during the step of solidification. In particular, during the latter, the bottom induction coil is deactivated and brought into contact with the susceptor, continuing to supply in the turns thereof a coolant so as to remove the heat present in the susceptor directly.

### BRIEF DESCRIPTION OF THE DRAWINGS

Further characteristics and advantages of the invention will appear clearly from the ensuing description of a non-limiting example of embodiment thereof, illustrated purely by way of example with reference to the figures of the annexed drawings, wherein:

FIG. 1 illustrates a schematic view in elevation and sectioned parallel to the axis of vertical symmetry of a device for melting and subsequent directional solidification of a semiconductor material, made according to the invention and only half of which is illustrated, the part removed being symmetrical;

FIG. 2 illustrates at an enlarged scale a perspective view three quarters from above of a bottom induction coil of the device of FIG. 1; and

FIGS. 3 and 4 are respective schematic illustrations of three different possible operating configurations of the induction coil of FIG. 2 and the consequent distributions of temperature in a graphite plate set between the induction coil and a crucible containing the semiconductor material to be heated.

### BEST MODE FOR CARRYING OUT THE INVENTION

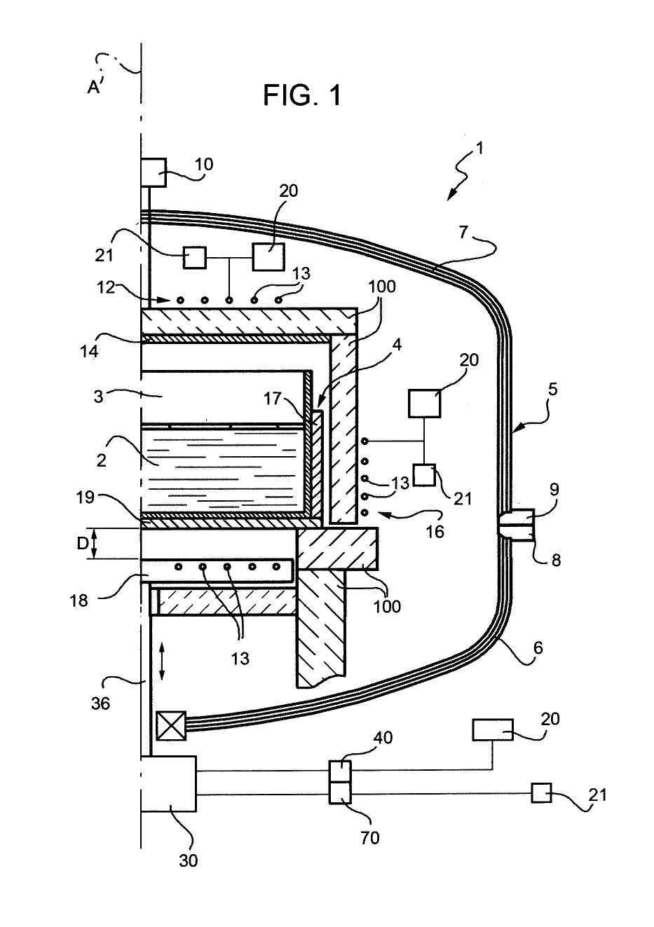

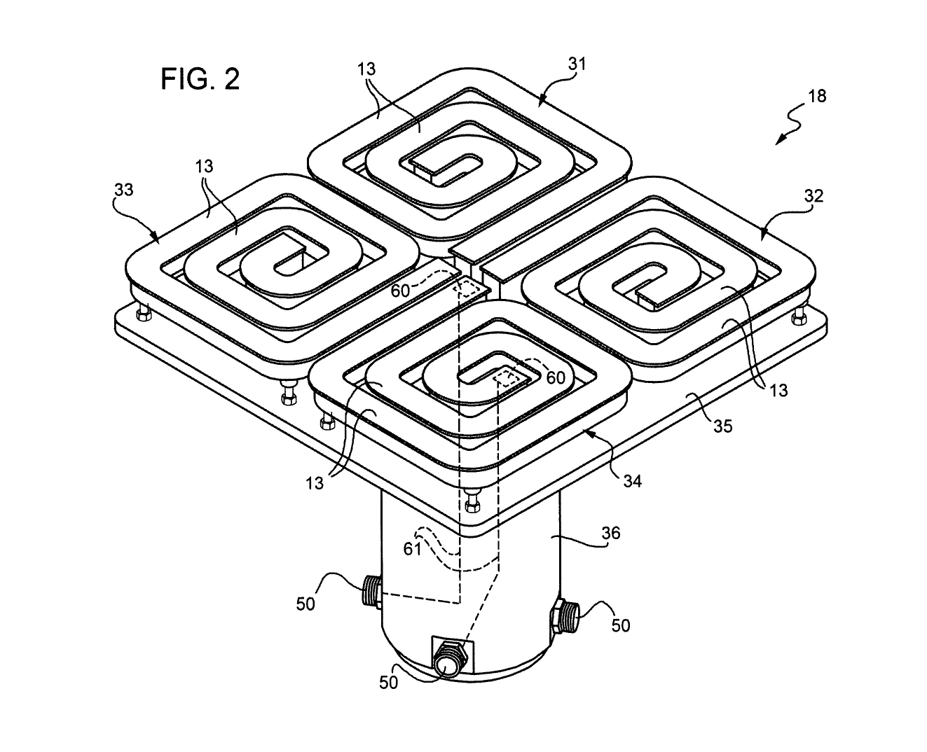

With reference to FIGS. 1 and 2, designated as a whole by 1 is a device for melting and subsequent directional solidification of a semiconductor material 2, typically to obtain multicrystalline silicon with “solar” degree of purity.

The device 1 comprises: at least one crucible 3 for the semiconductor material 2, preferably made of quartz or ceramic material, removably housed in a cup-shaped graphite container 4; and a fluid-tight casing 5, housing inside it the graphite container 4 and delimited by a bottom half-shell 6 and by a top half-shell 7, which are cup-shaped; the latter, which are preferably made of steel, are normally coupled on top of one another (FIG. 1) with their concavities facing one another and respective edges 8, 9 provided with appropriate gaskets (not illustrated) butted together in a fluid-tight way.

The device 1 further comprises means 10 for moving away the top half-shell 7 vertically from the bottom half-shell 6, in the case in point so that the casing 5 will assume an “open” configuration for enabling access to the graphite container 4.

The device 1 further comprises, according to one aspect of the invention: at least one top induction coil 12, in the non-limiting example illustrated with plane development, comprising turns 13, shaped, for example, according to a plane spiral, the induction coil being set, with interposition of a graphite plate 14 operatively associated thereto, facing a mouth of the graphite container 4; at least one lateral induction coil 16, set, in use, in the form of half-shells 6, 7 coupled around a side wall 17 of the graphite container 4; and a bottom induction coil 18, set facing a bottom wall 19 of the graphite container 4.

The device 1 further comprises: a.c. electrical-supply means 20, which are known and are consequently represented schematically by blocks, for supplying the induction coils 12, and 18 separately and independently of one another; and cooling means 21, which are also known and are consequently represented schematically by blocks, for supplying a coolant within the turns 13, which are hollow in so far as they are constituted by tubular elements, of the induction coils 12, 16 and 18.

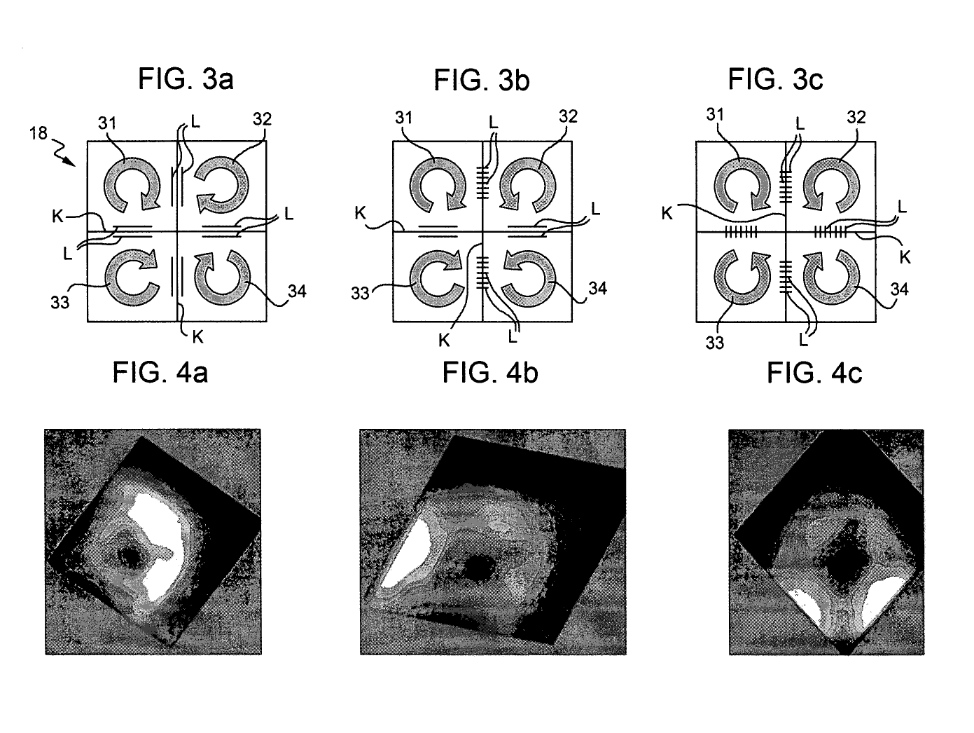

According to one aspect of the invention, the bottom induction coil 18 is vertically mobile so as to be able to vary in use its distance D (FIG. 3) from the bottom wall 19, via movement means 30, whilst the lateral induction coil 16 (FIGS. 5 and 6) includes a plurality of plane turns 13, i.e., each having a development in one and the same plane of lie, which are set coaxial with respect to an axis A of symmetry of the half-shells 6, 7, and are set on top of one another in the vertical direction.

According to a known technique, the side wall 17 and bottom wall 19 of the graphite container 4 and the graphite plate 14 have a composition and dimensions such as to constitute electromagnetic susceptors for the lateral induction coil 16, the bottom induction coil 18, and the top induction coil 12, respectively.

The cooling means 21 can be obtained so that the coolant used by them that circulates in the hollow turns 13 is a diathermic oil, instead of water. In this way, in the case of any leakage of coolant within the casing 5, during the process of melting or of directional solidification, or in the event of failure of the crucible 3 with consequent spilling of the molten silicon 2 in the bottom half-shell 6, there is no risk of explosions consequent upon the possible chemical reactions of silicon with water.

According to the main aspect of the invention, the bottom induction coil 18 (FIG. 2) comprises a plurality of windings 31, 32, 33 and 34, in the embodiment shown having plane development, arranged alongside one another in one and the same plane of lie defined by an insulated supporting plate 35, in turn carried by a stem or hub 36 that is moved within the half-shell 6 by the movement means 30 to vary the distance D in use.

Furthermore, according to the invention, electrical switching means 40, represented schematically with a block and not described in detail in so far as they are obvious for a person skilled in the art once their function has been identified and described, are prearranged between the windings 31-34 of the bottom induction coil 18 and the respective a.c. electrical-supply means 20 for connecting the windings 31-34 selectively to one another and to the means 20 according to different configurations, which differ from one another as regards the direction of circulation of the electric currents in the respective windings 31-34 set alongside one another, as represented schematically, for example, in FIG. 3.

According to the preferred embodiment, the bottom induction coil 18 includes four windings, designated precisely by 31, 32, 33, 34, arranged alongside one another in twos, according to a chequered scheme.

The windings 31-34 are in particular shaped each as a plane spiral (FIG. 2) obtained by bending a number of times on itself a copper tube to form the hollow turns 13 and subdivide the bottom induction coil 18 into respective adjacent sectors, represented schematically in FIG. 4, in which the windings 31-34 are also represented schematically by circular arrows having direction concordant with that of circulation of the electric currents therein, in which sectors respective lines of flux L of the magnetic field generated by the induction coil 18 have a similar pattern.

The switching means 40 are then such as to be designed to determine selectively between adjacent sectors a pattern of the lines of flux L that is, respectively, tangential (for example FIG. 4a), or normal (FIG. 4c) to the boundary lines K between one sector and the next, or, again, mixed (FIG. 4b).

As has been said, the cooling means 21 of at least the bottom induction coil 18 are designed to supply in the hollow turns 13 thereof a diathermic oil or else water, through the hub or stem 36, by means of respective pipe unions 50, for example, one in number for each winding 31-34; in particular, each winding 31-34 starts and terminates with a mouth 60 (FIG. 2), connected via hydraulic lines 61 inside the hub or stem 36 with the pipe unions 50, which are in turn connected in a known way with the cooling means 21.

Possibly, there may be provided between the windings 31-34 and the cooling means 21 hydraulic-switching means 70 (FIG. 1) for supplying, if needed, different flows of coolant in the turns 13 of the various windings 31-34.

On the basis of what has been described it is clear that, by means of the device 1 it is possible to implement effectively a method for carrying out control of the temperature of the semiconductor material 2 in a process for directional solidification of said material, in which the latter is melted and is subsequently subjected to controlled solidification and in which the melting step is performed by heating the semiconductor material contained in the crucible 3 by means of graphite susceptors 14, 17, 19, each operatively associated to at least one respective induction coil, 12, 16, and 18, respectively, and arranged so as to surround the crucible 3.

In particular, the method for controlling the temperature of the silicon 2 in the crucible 3 comprises the steps of:
setting under the crucible 3 a susceptor 19, in the case in point constituted by the base plate defining the bottom wall of the container 4, operatively associated to a bottom induction coil 18, comprising a plurality of windings 31-34 having a plane development and arranged alongside one another in one and the same plane of lie; and
selectively connecting the windings 31-34 to one another and to the respective a.c. electrical-supply means 20 for supply of the bottom induction coil 18 according to different configurations, illustrated schematically in FIG. 3, which differ from one another as regards the direction of circulation of the electric current, represented schematically by the direction of the circular arrows, in the respective windings 31-34, set alongside one another, which are also represented schematically by the circular arrows in FIG. 3.

In particular, the windings 31-34 of the bottom induction coil are connected to one another so that each winding 31-34 defines a sector of the induction coil 18 in which respective lines of flux L of the magnetic field have a similar pattern, and so that, in combination, the lines of flux L of adjacent sectors have a pattern respectively always tangential (FIG. 3a) or normal (FIG. 3c) to the boundary line K between one sector and the next.

Furthermore, the distance D between the bottom induction coil 18 and the respective graphite susceptor 19 associated thereto is varied according to the method of the invention, according to the need and, in particular, during the step of directional solidification, which is performed by interrupting the electrical supply of the bottom induction coil 18, keeping, however, in circulation a coolant in the hollow turns 13 thereof, and approaching the induction coil 18 to the susceptor 19 associated thereto until it is brought substantially into contact therewith, using as coolant a diathermic oil or else water, as already mentioned.

For this purpose, the induction coil 18 is set within a compartment defined by respective thermally insulating elements 100 that surround the susceptors 14, 17, 19, whereas the induction coils 12 and 16 are preferably arranged on the outside of said compartment and, hence, with the insulating elements 100 set between them and the susceptors 14, 17 associated thereto.

In this way, it has been experimentally found, as highlighted in FIG. 4, that it is possible to vary with extreme simplicity and in a way that can be implemented a number of times during one and the same process the heat that the bottom graphite susceptor 19 supplies to the crucible 3. FIG. 4a shows in particular the pattern of the temperatures (the areas with higher temperature are the lighter areas, according to the greyscale used in the graph of FIG. 4) in the susceptor when the configuration of the electric currents in the windings 31-34 is that of FIG. 3a. FIGS. 4b and 4c show likewise the appearance of the distribution of the temperatures in the susceptor 19 when the configuration of the electric currents is that of FIG. 4b and FIG. 4c, respectively.

Furthermore, also the control of the temperature of the silicon 2 during solidification is markedly facilitated by the particular constructional configuration of the induction coil 18 and by its use as heat exchanger, once the latter has been deactivated by detaching its own a.c. electrical-supply means 20.

1. A device (1) for melting and subsequent directional solidification of a semiconductor material (2), typically to obtain multicrystalline silicon with “solar” degree of purity, comprising at least one crucible (3) for the semiconductor material, preferably made of quartz or ceramic material, removably housed in a cup-shaped graphite container (4); at least one top induction coil (12), set, with at least interposition of a graphite plate (14) operatively associated thereto, facing to a mouth (15) of the graphite container; at least one lateral induction coil (16), set around a side wall (17) of the graphite container; at least one bottom induction coil (18), set facing a bottom wall (19) of the graphite container; a.c. electrical-supply means (20) for supplying said induction coils (12, 16, 18) separately and independently of one another; and cooling means (21) for supplying a coolant within respective hollow turns (13) of the induction coils; said device being characterized in that, in combination:
the at least one bottom induction coil (18) comprises a plurality of windings (31-34), arranged alongside one another in one and the same plane of lie defined by an insulated supporting plate (35);
electrical switching means (40), prearranged between the windings (31-34) of said at least one bottom induction coil (18) and the respective a.c. electrical-supply means (40) for selectively connecting the latter and the windings (31-34) to one another according to different configurations.

2. The device according to claim 1, characterized in that said different configurations differ from one another as regards the direction of circulation of the electric currents in the respective windings (31-34) set alongside one another.

3. The device according to claim 1, characterized in that said at least one bottom induction coil (18) includes four of said windings (31-34), arranged alongside one another in twos, according to a chequered scheme.

4. The device according to claim 1, characterized in that said windings (31-34) arranged alongside one another have a plane development being shaped each as a plane spiral.

5. The device according to claim 1, characterized in that said windings (31-34) divide the at least one bottom induction coil (18) into respective adjacent sectors in which respective lines of flux (L) of the magnetic field generated by the induction coil (18) have a similar pattern; said switching means (40) being designed to determine selectively between adjacent sectors a pattern of the lines of flux (L) respectively tangential or normal to the boundary line (K) between one sector and the next.

6. The device according to claim 1, characterized in that said at least one bottom induction coil (18) is vertically mobile so as to be able to vary in use its distance (D) from the bottom wail (19) of the graphite container (4).

7. The device according to claim 1, characterized in that said cooling means (21) of the at least the bottom induction coil (18) are designed to supply a diathermic oil in the hollow turns (13) thereof.

8. The device according to claim 1, characterized in that it further comprises, an openable fluid-tight casing (5) housing inside it the graphite container (4) and said induction coils (12, 16, 18).

9. A method for performing the control of the temperature in a process for directional solidification of a semiconductor material (2), wherein the semiconductor material is melted and is subsequently subjected to controlled solidification, said melting step being performed by heating the semiconductor material contained in a crucible (3) by means of graphite susceptors (14, 17, 19), each operatively associated to at least one respective induction coil (12, 16, 18) and arranged so as to surround the crucible, said method being characterized in that it comprises the steps of:
setting under the crucible (3) one said susceptor (19) operatively associated to at least one bottom induction coil (18) comprising a plurality of windings (31-34) arranged alongside one another in one and the same plane of lie; and
selectively connecting the windings (31-34) to one another and to respective a.c. electrical-supply means (40) for supply of the bottom induction coil according to different configurations that differ from one another as regards the direction of circulation of the electric currents in the respective windings (31-34) set alongside one another.

10. The method according to claim 9, characterized in that said windings (31-34) of the at least one bottom induction coil (18) are connected to one another so that each winding defines a sector of the induction coil in which respective lines (L) of flux of the magnetic field have a similar pattern; and so chat, in combination, the lines of flux (L) of adjacent sectors have a pattern that is respectively tangential or normal to the boundary line (K) between one sector and the next.

11. The method according to claim 9, characterized in that the distance (D) between said at least one bottom induction coil (18) and the respective graphite susceptor (19) associated thereto is varied.

12. The method according to claim 9, characterized in that the step of controlled solidification is performed by interrupting the electrical supply of the at least one bottom induction coil (18), keeping in circulation a coolant in respective hollow turns (13) thereof, and approaching the induction coil (18) to the susceptor (19) associated thereto until it is brought substantially into contact therewith.

13. The method according to claim 12, characterized in that a diathermic oil is used as coolant.
